(19) United States
(12) Patent Application Publication
(10) Pub. No.: US 2014/0006164 A1
(43) Pub. Date: Jan. 2, 2014

(54) METHODS AND SYSTEMS FOR TARGETING ADS BASED ON RISK BEHAVIOR METADATA

(71) Applicants: John BELLEGANTE, Mahomet, IL (US); Jonathan Kilroy, Champaign, IL (US); Allie K. Watfa, Urbana, IL (US); Dale Nussel, Mahomet, IL (US)

(72) Inventors: John BELLEGANTE, Mahomet, IL (US); Jonathan Kilroy, Champaign, IL (US); Allie K. Watfa, Urbana, IL (US); Dale Nussel, Mahomet, IL (US)

(73) Assignee: Yahoo! Inc., Sunnyvale, CA (US)

(21) Appl. No.: 13/537,775

(22) Filed: Jun. 29, 2012

(51) Int. Cl. G06Q 30/02

(52) U.S. Cl. 705/14.63; 705/14.66

(57) ABSTRACT

The present invention provides techniques for use in providing advertisers and other entities with information relating to target audiences. Techniques are provided in which driving related statistical information such as speed, acceleration, etc. may be obtained from risk assessment devices. The collected information may be used to calculate a risk assessment score. Ads may be selected, generated, or modified based on one or more of the risk assessment score, location information, and the user's online profile information. The ads may be transmitted to the user's mobile device or PC for display.

### BACKGROUND

Advertisers (including proxies, agents, or other entities acting on behalf of or in the interest of advertisers) compete for user attention. By effective referencing and use of topics of interest in their advertising, advertisers grab attention, build rapport with audiences, and increase brand cachet. For example, in maintaining distinctiveness and relevance, advertisers benefit from, among other things, knowledge of interests and trending interests of their target audiences.

One particular target audience of interest to advertisers is users who are traveling in vehicles. There is a need for techniques for use in, among other things, providing advertisers and other entities with information relating to users who are traveling.

### SUMMARY

Exemplary embodiments of the invention provide methods and systems for receiving data relating to a user's driving style a risk assessment device, wherein the risk assessment device is configured to monitor at least acceleration of a vehicle. The risk assessment device may be a device such as that used by auto insurance companies to collect driving statistics or may be a smartphone, tablet, navigation device, etc. The risk assessment may collect information such as miles driven, acceleration, braking, turns, speed, time of day vehicle is driven, current location, etc. The data may be received over a network, such as the Internet.

A level of risk taken by the user while driving may be determined based at least in part on the data. The level of risk may be defined as for example, low, medium, or high. In some embodiments, the level of risk may be assigned a numerical value such as 0.0, 0.5, or 1.0 corresponding to low, medium, or high, respectively. The level of risk may be derived from the collected data. For example, using the location information, it may be determined what the weather conditions were when the user was driving. In one example, if the user is driving fast, and taking fast turns during inclement weather conditions, it may be determined that the level of risk is high.

A frequency of the risk taken by the user while driving may be determined based at least in part on the data. The frequency of risk may be defined as for example, always, sometimes, or never. In some embodiments, the level of risk may be assigned a numerical value such as 1.0, 0.5, or 0.0 corresponding to always, sometimes, or never, respectively. The frequency of risk may be derived from the collected data. For example, it may be determined from the collected data, how often the user engages in risky driving behavior. In one example, engaging in risky driving behavior once a day may be designated as “always” or 1.0, once a month may be designated as “sometimes” or 0.5 and once a year may be designated as “never” or 0.0.

A risk assessment score may be determined for the user based at least in part on the level of the risk and the frequency of the risk. The risk assessment score (RAS) may be calculated using a formula, such as for example, RAS=(risk level+risk frequency+last risk)/3*100 In this formula, last risk refers to the length of time since the last time the user engaged in risky driving behavior. It may be defined as recently, a while back, or long time ago. In some embodiments, last risk may be assigned a numerical value such as 1.0, 0.5, or 0.0 corresponding to recently, a while back, or a long time ago, respectively.

An advertisement may be selected based at least in part on the risk assessment score. The risk assessment score may be mapped to a risk level range associated with the ad. For example, advertisements may be assigned risk level ranges based on the content or subject of the ad. In one example, ads related to mounting climbing are assigned a risk level range of 75-100, ads related to fishing are assigned a risk level range of 50-74, and ads related to spas are assigned a risk level range of 0-49. In some embodiments, the ad may be selected based on additional factors such as location, and/or the user's online profile. The user's online profile may provide additional information relating to the user's interests, such as the user's online browsing history, search history, etc.

The advertisement may be transmitted to the user's mobile device (e.g., smartphone, tablet, etc.) or to a user's PC. In some embodiments, the advertisement may be transmitted to a browser application which may be running on a PC or a mobile device.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

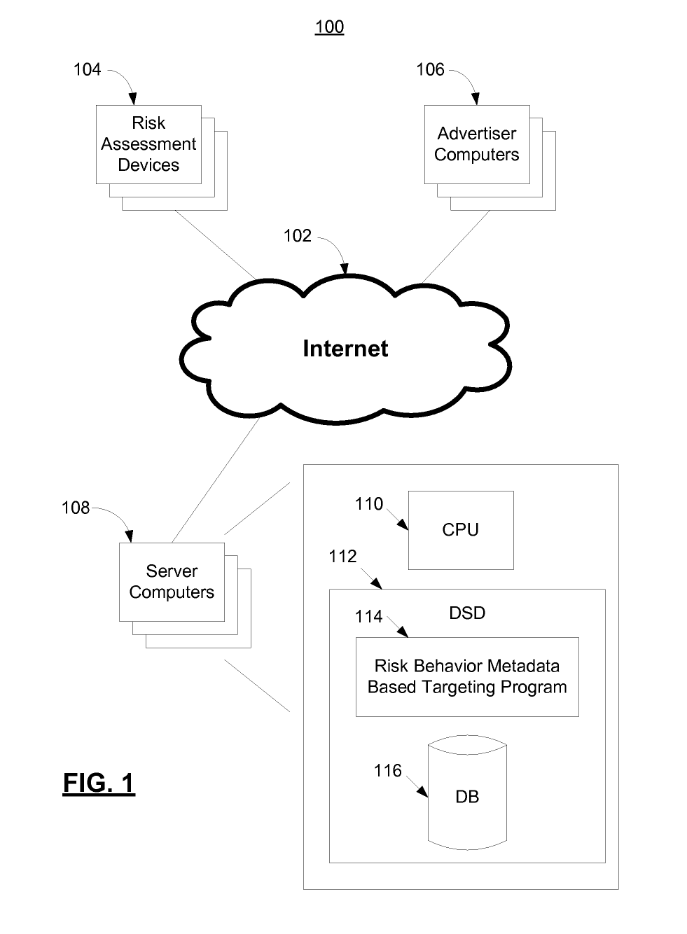

FIG. 1 is a distributed computer system 100 according to one embodiment of the invention. The system 100 includes risk assessment devices 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. In one embodiment, risk assessment devices 104 may be a monitoring device such as that used by auto insurance companies to monitor driving statistics. For example, State-Farm® provides an In-Drive Communicator™, which is a device that connects to a vehicle's on-board diagnostic port (OBD), collects driving statistics such as miles driven, acceleration, braking, turns, speed, time of day vehicle is driven, location, etc., and transmits the collected statistics to one or more servers. The invention further contemplates embodiments in which risk assessment devices 104 may be portable or handheld devices such as smart phones, PDAs, tablets, mobile navigation units, etc capable of monitoring at least acceleration. It will be apparent to one of ordinary skill in the art that modern mobile devices such as smart phones, tablets, etc. include one or more of an accelerometer, a gyroscope, a compass, and a GPS transmitter, and may be used to collect the driving statistics mentioned above using an “app” running on the mobile device. In some embodiments, risk assessment devices 104 may also include portable or in-vehicle navigation systems. Risk assessment devices 104 may also include one or more cellular radios and/or Wi-Fi to be able to transmit and receive data to/from server computers 108.

Each of the one or more computers 106 and 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, graphical advertisements, rich advertisements, video advertisements, etc.

As depicted, each of the server computers 108 includes one or more CPUs 110 and a data storage device 112. The data storage device 112 includes a database 116 and a Risk Behavior Metadata Based Targeting Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

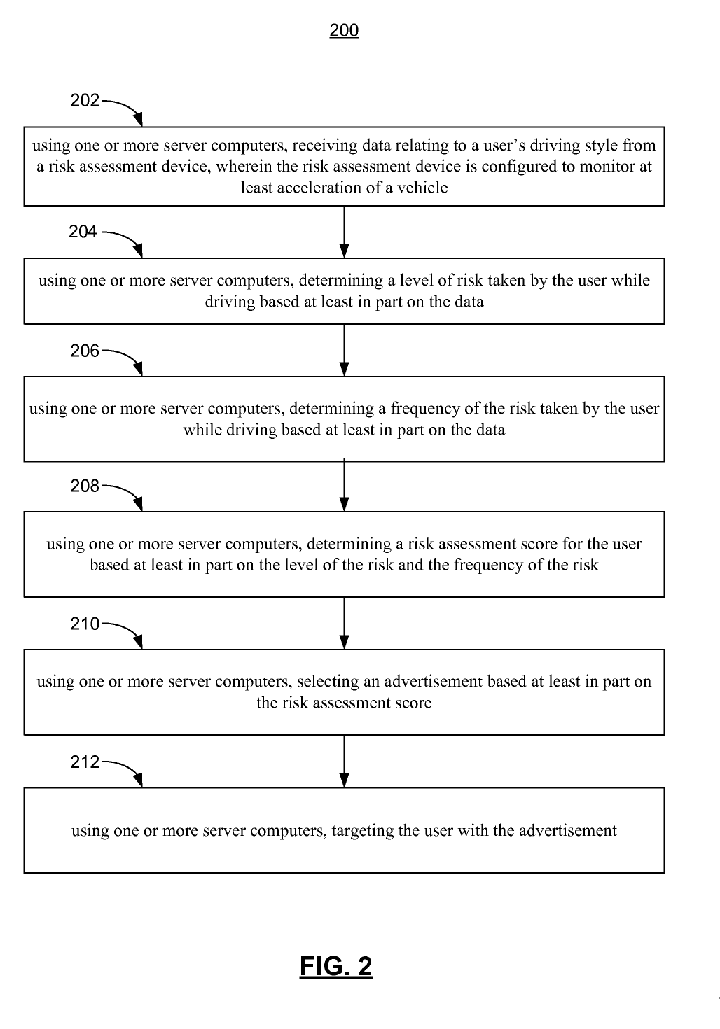

FIG. 2 is a flow diagram illustrating a method 200 according to one embodiment of the invention. At step 202, using one or more server computers, data relating to a user's driving style is received from a risk assessment device, wherein the risk assessment device is configured to monitor at least acceleration of a vehicle. As discussed above, the risk assessment device may be a device such as that used by auto insurance companies to collect driving statistics or may be a smartphone, tablet, navigation device, etc. The risk assessment may collect information such as miles driven, acceleration, braking, turns, speed, time of day vehicle is driven, current location, etc. The data may be received over a network, such as the Internet.

At step 204, using one or more server computers, a level of risk taken by the user while driving may be determined based at least in part on the data. The level of risk may be defined as for example, low, medium, or high. In some embodiments, the level of risk may be assigned a numerical value such as 0.0, 0.5, or 1.0 corresponding to low, medium, or high, respectively. The level of risk may be derived from the collected data. For example, using the location information, it may be determined what the weather conditions were when the user was driving. In one example, if the user is driving fast, and taking fast turns during inclement weather conditions, it may be determined that the level of risk is high.

At step 206, using one or more server computers, a frequency of the risk taken by the user while driving may be determined based at least in part on the data. The frequency of risk may be defined as for example, always, sometimes, or never. In some embodiments, the level of risk may be assigned a numerical value such as 1.0, 0.5, or 0.0 corresponding to always, sometimes, or never, respectively. The frequency of risk may be derived from the collected data. For example, it may be determined from the collected data, how often the user engages in risky driving behavior. In one example, engaging in risky driving behavior once a day may be designated as “always” or 1.0, once a month may be designated as “sometimes” or 0.5 and once a year may be designated as “never” or 0.0.

At step 208, using one or more server computers, a risk assessment score may be determined for the user based at least in part on the level of the risk and the frequency of the risk. The risk assessment score (RAS) may be calculated using a formula, such as for example, RAS=(risk level+risk frequency+last risk)/3*100 In this formula, last risk refers to the length of time since the last time the user engaged in risky driving behavior. It may be defined as recently, a while back, or long time ago. In some embodiments, last risk may be assigned a numerical value such as 1.0, 0.5, or 0.0 corresponding to recently, a while back, or a long time ago, respectively.

At step 210, using one or more server computers, an advertisement may be selected based at least in part on the risk assessment score. The risk assessment score may be mapped to a risk level range associated with the ad. For example, advertisements may be assigned risk level ranges based on the content or subject of the ad. In one example, ads related to mounting climbing are assigned a risk level range of 75-100, ads related to fishing are assigned a risk level range of 50-74, and ads related to spas are assigned a risk level range of 0-49. In some embodiments, the ad may be selected based on additional factors such as location, and/or the user's online profile. The user's online profile may provide additional information relating to the user's interests, such as the user's online browsing history, search history, etc.

At step 212, using one or more server computers, the user is targeted with the advertisement. The advertisement may be transmitted to the user's mobile device (e.g., smartphone, tablet, etc.) or to a user's PC. In some embodiments, the advertisement may be transmitted to a browser application which may be running on a PC or a mobile device.

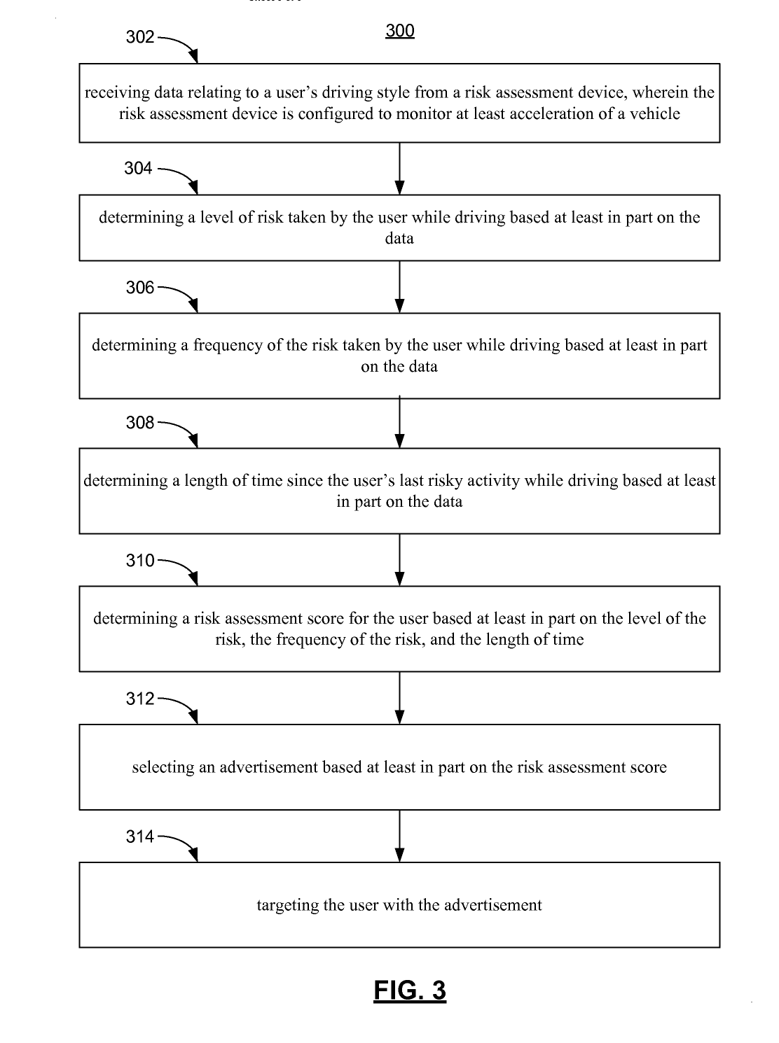

FIG. 3 is a flow diagram illustrating a method 300 according to one embodiment of the invention. At step 302, using one or more server computers, data relating to a user's driving style is received from a risk assessment device, wherein the risk assessment device is configured to monitor at least acceleration of a vehicle. As discussed above, the risk assessment device may be a device such as that used by auto insurance companies to collect driving statistics or may be a smartphone, tablet, navigation device, etc. The risk assessment may collect information such as miles driven, acceleration, braking, turns, speed, time of day vehicle is driven, current location, etc. The data may be received over a network, such as the Internet.

At step 304, using one or more server computers, a level of risk taken by the user while driving may be determined based at least in part on the data. The level of risk may be defined as for example, low, medium, or high. In some embodiments, the level of risk may be assigned a numerical value such as 0.0, 0.5, or 1.0 corresponding to low, medium, or high, respectively. The level of risk may be derived from the collected data. For example, using the location information, it may be determined what the weather conditions were when the user was driving. In one example, if the user is driving fast, and taking fast turns during inclement weather conditions, it may be determined that the level of risk is high.

At step 306, using one or more server computers, a frequency of the risk taken by the user while driving may be determined based at least in part on the data. The frequency of risk may be defined as for example, always, sometimes, or never. In some embodiments, the level of risk may be assigned a numerical value such as 1.0, 0.5, or 0.0 corresponding to always, sometimes, or never, respectively. The frequency of risk may be derived from the collected data. For example, it may be determined from the collected data, how often the user engages in risky driving behavior. In one example, engaging in risky driving behavior once a day may be designated as “always” or 1.0, once a month may be designated as “sometimes” or 0.5 and once a year may be designated as “never” or 0.0.

At step 308, using one or more server computers, a length of time since the last time the user engaged in risky driving behavior may be determined. It may be defined as recently, a while back, or long time ago. In some embodiments, last risk may be assigned a numerical value such as 1.0, 0.5, or 0.0 corresponding to recently, a while back, or a long time ago, respectively.

At step 310, using one or more server computers, a risk assessment score may be determined for the user based at least in part on the level of the risk, the frequency of the risk, and the length of time. The risk assessment score (RAS) may be calculated using a formula, such as for example, RAS=(risk level+risk frequency+last risk)/3*100.

At step 312, using one or more server computers, an advertisement may be selected based at least in part on the risk assessment score. The risk assessment score may be mapped to a risk level range associated with the ad. For example, advertisements may be assigned risk level ranges based on the content or subject of the ad. In one example, ads related to mounting climbing are assigned a risk level range of 75-100, ads related to fishing are assigned a risk level range of 50-74, and ads related to spas are assigned a risk level range of 0-49. In some embodiments, the ad may be selected based on additional factors such as location, and/or the user's online profile.

At step 314, using one or more server computers, the user is targeted with the advertisement. The advertisement may be transmitted to the user's mobile device (e.g., smartphone, tablet, etc.) or to a user's PC. In some embodiments, the advertisement may be transmitted to a browser application which may be running on a PC or a mobile device.

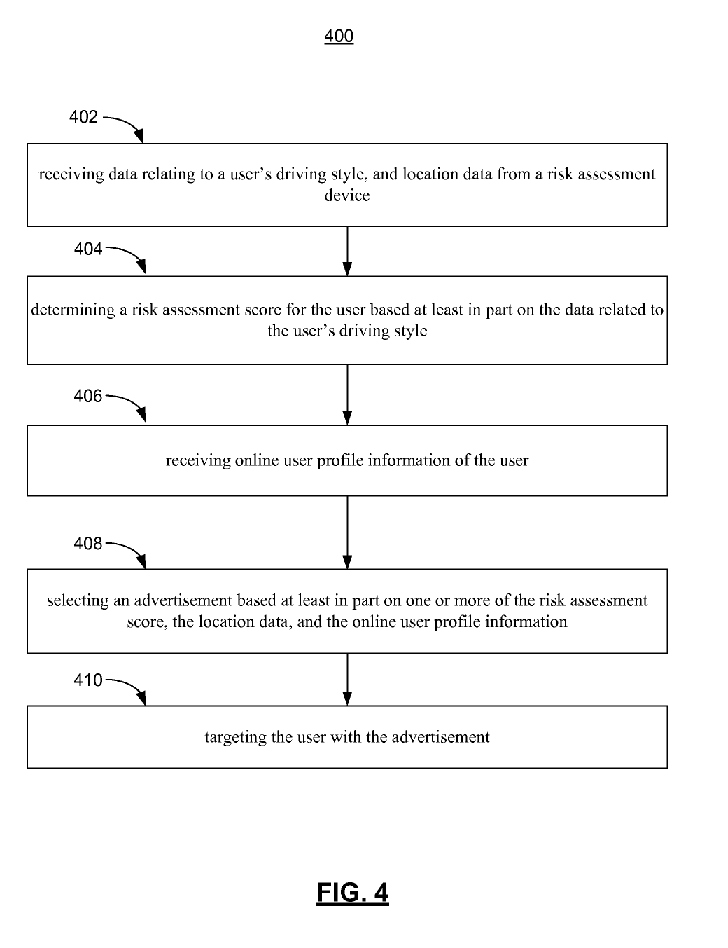

FIG. 4 is a flow diagram illustrating a method 400 according to one embodiment of the invention. At step 402, using one or more server computers, data relating to a user's driving style, and location data may be received from a risk assessment device. At step 404, using one or more server computers, a risk assessment score is determined for the user based at least in part on the data related to the user's driving style. As discussed above, the risk assessment score may be calculated using the level of risk, frequency of risk, and length of time since the user's last risky driving activity.

At step 406, using one or more server computers, online user profile information of the user is received. At step 408, using one or more server computers, an advertisement is selected based at least in part on one or more of the risk assessment score, the location data, and the online user profile information. At step 410, using one or more server computers, the user is targeted with the advertisement. The advertisement may be transmitted to the user's mobile device (e.g., smartphone, tablet, etc.) or to a user's PC. In some embodiments, the advertisement may be transmitted to a browser application which may be running on a PC or a mobile device. In some embodiments, a history of the ads that were transmitted to the user may be stored in a database.

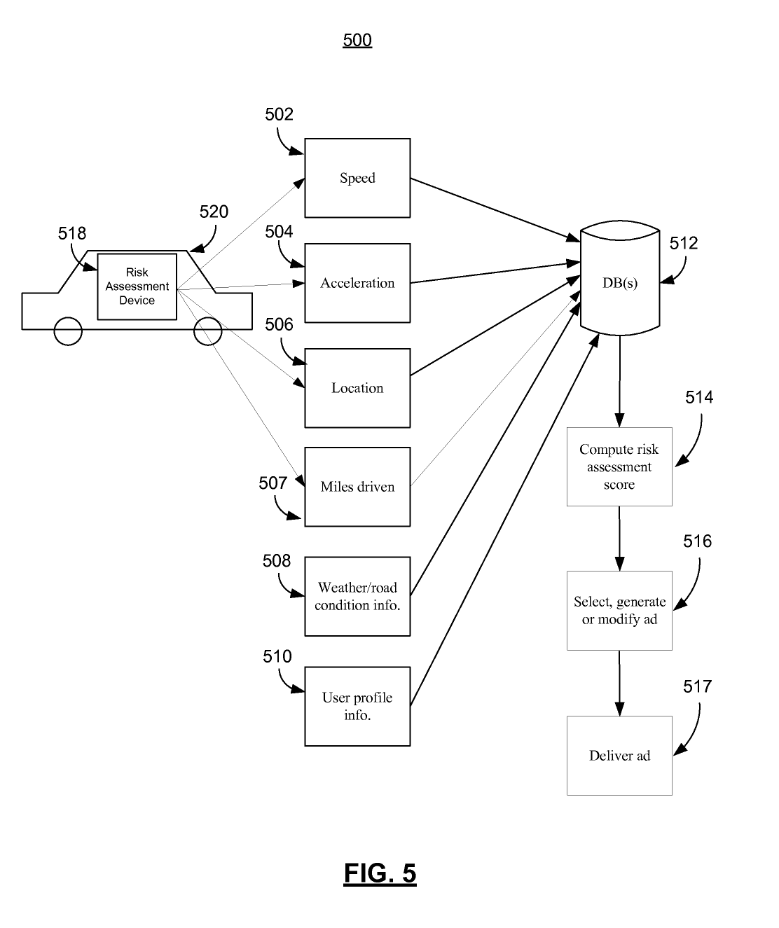

FIG. 5 is a block diagram 500 illustrating one embodiment of the invention. One or more data stores or databases 512 are depicted. Various types of information are stored in the database 512. In particular, types of depicted information stored in the database 512 include, potentially among many other types of information, driving related statistical information collected from risk assessment device 518 such as, speed 502, acceleration 504, location 506, and miles driven 507. Risk assessment device 518 may be connected to vehicle 520 (e.g., such as the device used by auto insurance companies) or may be a smartphone in the user's possession. Database 512 may also store information from various other sources such as weather and road condition information 508, user online profile information 510, etc. In some embodiments, a history of the ads that were transmitted to the user may be stored in database 512. The information stored in database 512 may be obtained, gathered, or generated in various ways from various sources. For example, weather and road condition information 508 may be obtained from third party sources such as www.weather.com and/or from Yahoo! sources (e.g., weather.yahoo.com). Similarly, user profile information 510 may also be obtained from a third party source such as Facebook. Alternatively, or in addition, a user's existing Yahoo profile may be obtained.

Block 514 represents computing the user's risk assessment score. As previously discussed, the risk assessment score may be determined based at least in part on the level of the risk, the frequency of the risk, and the length of time. The risk assessment score (RAS) may be calculated using a formula, such as for example, RAS=(risk level+risk frequency+last risk)/3*100.

Block 516 represents selection, generation or modification of an advertisement. The advertisement may be selected, generated, or modified based at least in part on one or more of the risk assessment score, location information and/or the user profile information. Block 518 represents transmission of the advertisement to the user. In one embodiment, the advertisement may be transmitted wirelessly over, for example, a cellular data connection to the user's mobile device. In another embodiment, the advertisement may be transmitted to the user's PC.

Some embodiments of the invention help provide advertisers with information and tools to allow them to better compete for user attention by utilizing and referencing topics of interest. Advertisers can benefit, for example, from, for a particular target audience of interest to the advertiser, information that allows timely and effective targeting. One particular way to capture user attention is to target advertisements to the users based on the users' risk profile. The user's risk profile provides information relating to the user's “risk appetite”. By using the data collected from the risk assessment device to calculate the risk assessment score, which provides an indication of the user's “risk appetite” (e.g., whether the user takes risks or not), allows targeting of the user with ads which appeal to the user's risk level. For example, people engaged in risky behavior would be more likely to purchase a motorcycle, hand-glider, parachute lessons, etc. By taking a user's “risk appetite” into account, ad content may be selected, generated or modified to take the user's risk assessment into account. For example, users who engage in higher risk behavior will be more likely to have their attention grabbed by an ad that features rock climbers, race car drivers, etc. In another example, users with a lower risk assessment will respond better to products presented in a more calm environment, such as a field of flowers.

In some embodiments, the risk assessment score may be used in conjunction with the user's online profile to target the user with ads. For example, if the user's online profile indicates that the user frequently searches for travel locations, and the user's risk assessment is high, an ad for higher risk activities (e.g., sky diving) at the searched location may be selected. In some embodiments, ads may be modified to match the user's risk assessment. For example, a bike ad may show biking on a mountain for users with high risk assessments, or biking in the park for users with low risk assessments.

While the invention is described with reference to the above drawings, the drawings are intended to be illustrative, and the invention contemplates other embodiments within the spirit of the invention.

1. A method comprising:
using one or more server computers, receiving data relating to a user's driving style from a risk assessment device, wherein the risk assessment device is configured to monitor at least acceleration of a vehicle;
using one or more server computers, determining a level of risk taken by the user while driving based at least in part on the data;
using one or more server computers, determining a frequency of the risk taken by the user while driving based at least in part on the data;
using one or more server computers, determining a risk assessment score for the user based at least in part on the level of the risk and the frequency of the risk;
using one or more server computers, selecting an one or more advertisement subjects based at least in part on the risk assessment score, wherein the one or more advertisement subjects are each assigned a range of risk levels; and
using one or more server computers, targeting the user with an advertisement related to the one or more advertisement subjects.

2. The method of claim 1, wherein the risk assessment device is configured to monitor location information.

3. The method of claim 1, wherein the risk assessment device is a smartphone.

4. The method of claim 1, wherein targeting the user comprises transmitting the advertisement to a browser application.

5. The method of claim 1, wherein selecting the one or more advertisement subjects further comprises selecting the one or more advertisement subjects based at least in part on the risk assessment score and an online profile of the user.

6. The method of claim 2, wherein selecting the one or more advertisement subjects further comprises the one or more advertisement subjects based at least in part on the risk assessment score and the location information as monitored by the risk assessment device.

7. The method of claim 1, wherein the one or more advertisement subjects further comprises the one or more advertisement subjects based at least in part on matching the risk assessment score to the range of risk levels associated with the advertisement subjects.

8. The method of claim 1, wherein determining the risk assessment score comprises determining the risk assessment score based at least in part on the level of the risk, the frequency of the risk and a length of time since the user's last risky activity while driving.

9. The method of claim 1, further comprising:
storing a history of advertisements comprising at least information related to the advertisement targeted to the user.

10. A system comprising:
one or more server computers coupled to a network;
one or more databases coupled to the one or more server computers; and
a risk assessment device configured to monitor at least acceleration of a vehicle;
wherein the one or more server computers are configured for:
receiving data relating to a user's driving style from the risk assessment device;
determining a level of risk taken by the user while driving based at least in part on the data;
determining a frequency of the risk taken by the user while driving based at least in part on the data;
determining a risk assessment score for the user based at least in part on the level of the risk and the frequency of the risk;
selecting one or more advertisement subjects based at least in part on the risk assessment score, wherein the one or more advertisement subjects are each assigned a a range of risk levels; and
targeting the user with an advertisement related to the one or more advertisement subjects.

11. The system of claim 10, wherein the risk assessment device is further configured to monitor location information.

12. The system of claim 10, wherein the risk assessment device is a smartphone.

13. The system of claim 10, wherein targeting the user comprises transmitting the advertisement to a browser application.

14. The system of claim 10, wherein the one or more advertisement subjects further comprises the one or more advertisement subjects based at least in part on the risk assessment score and an online profile of the user.

15. The system of claim 11, wherein the one or more advertisement subjects further comprises the one or more advertisement subjects based at least in part on the risk assessment score and the location information as monitored by the risk assessment device.

16. The system of claim 10, wherein the one or more advertisement subjects further comprises the one or more advertisement subjects based at least in part on matching the risk assessment score to the range of risk levels associated with the advertisement subjects.

17. The system of claim 10, wherein determining the risk assessment score comprises determining the risk assessment score based at least in part on the level of the risk, the frequency of the risk and a length of time since the user's last risky activity while driving.

18. The system of claim 10, wherein the server computers are further configured for:
storing a history of advertisements comprising at least information related to the advertisement targeted to the user.

19. The system of claim 10, wherein the risk assessment device is a smartphone.

20. A non-transitory computer readable storage medium having stored thereon instructions for causing a computer to execute a method, the method comprising:
receiving data relating to a user's driving style from a risk assessment device, wherein the risk assessment device is configured to monitor at least acceleration of a vehicle;
determining a level of risk taken by the user while driving based at least in part on the data;
determining a frequency of the risk taken by the user while driving based at least in part on the data;
determining a length of time since the user's last risky activity while driving based at least in part on the data;
determining a risk assessment score for the user based at least in part on the level of the risk, the frequency of the risk, and the length of time;
selecting one or more advertisement subjects based at least in part on the risk assessment score, wherein the one or more advertisement subjects are each assigned a range of risk levels; and
targeting the user with an advertisement related to the one or more advertisement subjects.
